(19) United States
(12) Patent Application Publication
(10) Pub. No.: US 2025/0158091 A1
(43) Pub. Date: May 15, 2025

(54) SEPARATOR PLATE FOR AN ELECTROCHEMICAL SYSTEM AND ASSOCIATED ELECTROCHEMICAL SYSTEM COMPRISING A PLURALITY OF SEPARATOR PLATES

(71) Applicant: Reinz-Dichtungs-GmbH, Neu-Ulm (DE)

(72) Inventors: Andre SPEIDEL, Bussmannshausen (DE); Bernadette GRÜNWALD, Ulm (DE); Thomas STÖHR, Laupheim (DE)

(21) Appl. No.: 18/945,346

(22) Filed: Nov. 12, 2024

(30) Foreign Application Priority Data
Nov. 13, 2023 (DE) 20 2023 106 624.0

(51) Int. Cl. H01M 8/026; H01M 8/0254; H01M 8/0263; H01M 8/0267; H01M 8/1004

(52) U.S. Cl. CPC H01M 8/026; H01M 8/0254; H01M 8/0263; H01M 8/0267; H01M 8/1004

(57) ABSTRACT

The present disclosure relates to a separator plate for an electrochemical system and an electrochemical system comprising at least one such separator plate. A first individual plate of the separator plate has, embossed on a first side, webs that delimit channels configured for guiding a first fluid. Between bases of the channels and the adjoining web flanks are first transition regions with a first embossing radius. On a second side of the first individual plate, the channels form protrusions and the webs form grooves for guiding a second fluid. Between bases of the grooves are second transition regions with a second embossing radius. The first individual plate forms a plurality of stiffening structures that are arranged in the first and/or second transition regions. The stiffening structures form local bulges with a radius greater than the respective embossing radius and which extend over a height less than a web height.

### CROSS REFERENCE TO RELATED APPLICATION

This application claims priority to German Utility Model Application No. 20 2023 106 624.0, entitled “SEPARATOR PLATE FOR AN ELECTROCHEMICAL SYSTEM AND ASSOCIATED ELECTROCHEMICAL SYSTEM COMPRISING A PLURALITY OF SEPARATOR PLATES”, filed Nov. 13, 2023. The entire contents of the above-identified application is hereby incorporated by reference for all purposes.

### TECHNICAL FIELD

The present disclosure relates to a separator plate for an electrochemical system and an electrochemical system comprising at least one such separator plate.

### BACKGROUND AND SUMMARY

Known electrochemical systems, for example fuel cell systems or electrochemical compressor systems, redox flow batteries and electrolyzers, usually comprise a plurality of separator plates which are arranged in a stack, such that in each case two adjacent separator plates enclose an electrochemical cell. The separator plates often comprise two individual plates, which are connected to each other along their rear sides facing away from the electrochemical cells. In electrolyzers, for example, the separator plates can also comprise just an individual plate. The separator plates can be used, for example, for electrically contacting the electrodes of the individual electrochemical cells (e.g. fuel cells) and/or for electrically connecting adjacent cells (series connection of the cells).

The individual plates of the separator plates may comprise channel structures for supplying the cells with one or more media and/or for transporting media away from the cells. In the case of fuel cells, the media can be, for example, fuels (e.g. hydrogen or methanol), reaction gases (e.g. air or oxygen) or a coolant as supplied media, and reaction products and heated coolant as discharged media. Furthermore, the separator plates may serve for transferring the waste heat produced in the electrochemical cell, as is produced for instance during the conversion of electrical or chemical energy in a fuel cell, and may be configured to seal the various media channels or cooling channels from one another and/or from the external environment. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent separator plates of the stack, or into the cavity formed by the individual plates of the separator plate, or can be discharged from the cells or from the cavity. The electrochemical cells, in particular of a fuel cell, may, for example, each comprise a membrane electrode assembly (or MEA) with a respective polymer electrolyte membrane (PEM) and electrodes. The MEA can also have one or more gas diffusion layers (GDL), which are usually oriented towards the separator plates, in particular towards the separator plates of fuel cell systems and are designed, for example, as a carbon fleece. In an example fuel cell, hydrogen carried on an anode side is typically converted to water, with oxygen being carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are guided separately from the anode to the cathode so that the electric current can be utilized.

The individual plates of the separator plates are typically embossed to form the web and channel structures. In application areas of electrochemical systems, particularly in the automotive and aviation sectors, high demands are placed on electrochemical systems. During the embossing process, springback leads to bulging effects and therefore shape deviations. A high number of embossed webs and channels can increase this detrimental effect.

It is therefore the object of the present disclosure to propose an improved, in particular stiffened, separator plate and/or an improved electrochemical system comprising at least one such separator plate, in particular in such a way that bulging effects are reduced.

According to the present disclosure, this object is at least partially solved by a separator plate and/or an electrochemical system having the features described herein.

The proposed separator plate for an electrochemical system comprises a first individual plate.

The first individual plate has, on a first side, embossed webs with web flanks that at least in sections delimit channels. The web flanks, in particular together with channel bases formed between two web flanks, can form the channels. The channels are configured to guide a first fluid. The first individual plate has, between the channel bases and the adjoining web flanks, first transition regions with a first embossing radius.

On a second side of the first individual plate, the channels form protrusions and the webs form grooves for guiding a second fluid. The first individual plate has, between bases of the grooves and adjoining flanks of the protrusions that form the grooves, second transition regions with a second embossing radius.

The first individual plate forms a plurality of stiffening structures that are arranged in the first and/or second transition regions, wherein the stiffening structures form local bulges, wherein the bulges have a radius that is greater than the respective embossing radius. Furthermore, the bulges extend over a height that is less than the web height. For example, the maximum height of the bulges can therefore be less than the web height. A height of the bulges can be measured, for example, along a direction orthogonal to the plane of the planar surface.

The stiffening structures can reduce bulging effects. As used herein, the term “bulging effects” refers to undesirable shape deviations resulting from springback that occurs during the embossing process, and is separate and distinct from the bulges formed by the stiffening structures.

The radii of the or some of the bulges can approach infinity, especially if the bulges are configured as inclined planes. The radii can be viewed in particular in the cross-section of the channels and grooves, i.e. perpendicular to the macroscopic channel extension.

A plane surface level can extend through the channel bases. The web height can be defined as the maximum height of the web measured orthogonally to the plane of the flat surface and starting from the plane of the flat surface. It can also include the simple material thickness so that it is measured from the same surface of the material.

At least some of the stiffening structures can be bulged into a channel in the first transition region and protrude into the channel. Additionally or alternatively, at least some of the stiffening structures in the second transition region can be bulged into a groove and project into the groove.

The stiffening structures can have a maximum longitudinal extension along the longitudinal channel extension or groove extension, which is greater than 0.1 times the web height, optionally greater than 0.15 times the web height, optionally preferably greater than 0.2 times the web height.

The stiffening structures can have a maximum longitudinal extension along the longitudinal channel extension or groove extension that is smaller than 2.5 times the web height, optionally smaller than 1.5 times the web height, optionally smaller than the web height.

The stiffening structures can have a maximum longitudinal extension along the longitudinal channel extension or groove extension that is greater than 120 μm, optionally greater than 130 μm, optionally greater than 150 μm.

The stiffening structures can have a maximum longitudinal extension along the longitudinal channel extension or groove extension that is less than 3 mm, optionally less than 2 mm, optionally less than 1 mm.

The stiffening structures can have a maximum lateral extension within the respective channel or within the respective groove, transverse, optionally orthogonal, to the longitudinal channel extension or groove extension, which is greater than 0.2 times the channel width measured at half height in channel sections without local bulges or in the case of stiffening structures formed in grooves, is greater than 0.2 times the groove width measured at half height in groove sections without local bulges, optionally greater than 0.3 times the channel width measured at half height in channel sections without local bulges, or in the case of stiffening structures formed in grooves, is greater than 0.3 times the groove width measured at half height in groove sections without local bulges, optionally greater than 0.4 times the channel width measured at half height in channel sections without local bulges, or in the case of stiffening structures formed in grooves, is greater than 0.4 times the groove width measured at half height in groove sections without local bulges.

The stiffening structures in a channel can have a maximum lateral extension within the respective channel or within the respective groove, transverse, optionally orthogonal, to the longitudinal channel extension or groove extension which is smaller than the channel width measured at half height in channel sections without local bulges, optionally smaller than 0.9 times the channel width measured at half height in channel sections without local bulges, optionally smaller than 0.8 times the channel width measured at half height in channel sections without local bulges.

The stiffening structures in a groove can have a maximum lateral extension within the respective channel or within the respective groove, transverse, optionally orthogonal, to the longitudinal channel extension or groove extension which is smaller than the groove width measured at half height in groove sections without local bulges, optionally smaller than 0.9 times the groove width measured at half height in groove sections without local bulges, optionally smaller than 0.8 times the groove width measured at half height in groove sections without local bulges.

The stiffening structures, thus the bulges, can have a maximum extension in the direction of the web height, i.e. in a direction orthogonal to the plane of the flat surface, which is at most 95%, optionally at most 90%, optionally at most 80% of the web height.

The web flank comprising the stiffening structure in its section comprising the stiffening structure can be inclined by a maximum of 55°, optionally by a maximum of 50°, optionally by a maximum of 45° to the plate plane in the region of the greatest curvature of the stiffening structure.

The above-mentioned dimensions or ratios of the stiffening structures can be advantageous, for example in order to not, or at least minimally or even positively, influence or redirect the flow properties of the fluid to be conducted through the channels or grooves, and on the other hand to stiffen the separator plate.

The stiffening structures can be arranged in a plurality of channels and/or a plurality of grooves.

The stiffening structures in the longitudinal course of the channel can originate from a first and/or a second web flank that delimits the respective channel and/or can alternately originate in the longitudinal groove course from a first and/or a second protrusion flank that delimits the respective groove.

The stiffening structures can be arranged only in channels or only in grooves. However, they can also be arranged in channels as well as in grooves.

The stiffening structures of a channel in the direction of channel extension can be arranged offset to the stiffening structures of an adjacent groove.

The separator plate can have more stiffening structures in the longitudinal and/or transverse direction in the central regions of the separator plate than in the edge regions of the separator plate. A longitudinal direction can extend along the longitudinal extension of the channels and/or grooves and a transverse direction can run transversely, for example, orthogonally to the longitudinal extension. The central region can be at a greater distance from the edge in the longitudinal and/or transverse direction than an edge region. The stiffening structures may be arranged in the active region of the separator plate. Optionally, the stiffening structures are only arranged in the active region of the separator plate, while no stiffening structures are arranged in the distribution or collection region.

The stiffening structures can be distributed longitudinally and/or transversely across the separator plate. In addition or alternatively, the stiffening structures can be spaced apart from each other in the longitudinal and/or transverse direction, at least in certain regions. Additionally or alternatively, the stiffening structures can have varying distances from one another in the longitudinal and/or transverse direction, at least in certain regions.

Optionally, the webs and channels in an intermediate region between two closest stiffening structures formed in the same webs and/or channels are shaped in such a way that they have the same structure over the entire length of such an intermediate region. This means that the embossing radii and flank angles as well as the web heights and channel depths remain constant over the entire length of such an intermediate region. Optionally, an intermediate region extends over a length that is at least 1.5 times, optionally at least twice, optionally at least three times the length of a stiffening structure in the x-direction.

On the one hand, all of the stiffening structures can be essentially identical in terms of their geometry. However, it is also possible for at least two of the stiffening structures to have different geometries. They can therefore differ in terms of their radii, directions of curvature, maximum longitudinal and/or lateral extension and/or inclination of the web flanks.

Optionally, the stiffening structures are designed in such a way that the web height does not change over their course in the x-direction, but remains constant both in the transverse stiffening region and in the intermediate regions.

The separator plate can have a second individual plate connected to the first individual plate. The second individual plate can be connected to the first individual plate on a second side facing away from the first side.

The second individual plate can have webs embossed on a first side of the second individual plate with web flanks that at least in sections delimit channels. The web flanks, in particular together with channel bases formed between two web flanks, can form the channels. The channels are configured to guide a third fluid. The second individual plate can have third transition regions with a third embossing radius between the bases of the channels and the adjoining web flanks.

On a second side of the second individual plate, the channels can form protrusions and the webs can form grooves for guiding the second fluid. The second individual plate can have fourth transition regions with a fourth embossing radius between bases of the grooves and adjoining flanks of the protrusions that delimit the grooves at least in sections.

The second individual plate can form a plurality of stiffening structures, which are arranged in the third and/or fourth transition regions. The stiffening structures in the third transition regions can be bulged locally into the channels and in the fourth transition regions they can be bulged locally into the grooves. The bulges can have a radius that is larger than the respective embossing radius. In the direction orthogonal to the plate plane, the bulges can be smaller than a web height of the second individual plate. The radii of the or some of the bulges can approach infinity, especially if the bulges are configured as inclined planes.

The stiffening structures of the first individual plate may differ from the stiffening structures of the second individual plate in at least some of their properties.

The first individual plate can be an anode plate and the second individual plate can be a cathode plate or vice versa.

The first and second individual plates can differ at least in their web heights. In addition or alternatively, the first and second individual plates can differ in the width of the web. However, both individual plates may have the same period length for a pair consisting of a web and a channel. The first and second individual plates can, for example, have the same shape and/or dimensions and/or arrangement density of stiffening structures. The first and second individual plates can be completely or partially identical.

The channels in the active region of the first and second individual plates can extend in a straight line and extend parallel to each other. The channels in the active region of at least one individual plate can also extend in a wavelike manner, with the channels of this active region of this individual plate optionally extending parallel to one another. They have a macroscopic flow direction that is optionally identical in both individual plates.

At least some of the stiffening structures of the first individual plate can overlap the stiffening structures of the second individual plate in an orthogonal projection onto the second individual plate and/or be arranged offset to these.

The present disclosure further relates to an electrochemical system comprising at least separator plates as described above, optionally comprising a plurality of separator plates as described above.

Exemplary embodiments of the separator plate and of the electrochemical system are illustrated in the figures and will be explained in more detail on the basis of the following description.

### BRIEF DESCRIPTION OF THE FIGURES

FIG. 1 schematically shows, in a perspective view, an electrochemical system comprising a plurality of separator plates arranged in a stack.

FIG. 2 schematically shows, in a perspective view, two separator plates of the system according to FIG. 1 with a membrane electrode assembly (MEA) arranged between the separator plates.

FIG. 3 schematically shows a cross-section through a plate stack of a system in the manner of the system according to FIG. 1.

FIG. 4A schematically shows a plan view of an individual plate.

FIG. 4B schematically shows the individual plate shown in FIG. 4A as a bending beam.

FIG. 5A schematically shows a perspective view of a section of an individual plate of a system of the type shown in FIG. 1.

FIG. 5B schematically shows a top view of the section shown in FIG. 5A.

FIG. 5C schematically shows a cross-section through the section shown in FIG. 5A along the section line B-B shown in FIG. 5B.

FIG. 5D schematically shows a cross-section through the section shown in FIG. 5A along the section line C-C shown in FIG. 5B.

FIG. 5E schematically shows a cross-section through the section shown in FIG. 5A along the section line F-F shown in FIG. 5B.

FIG. 6A schematically shows a perspective view of a section of an individual plate of a system of the type shown in FIG. 1.

FIG. 6B schematically shows a top view of the section shown in FIG. 6A.

FIG. 6C schematically shows a cross-section through the section shown in FIG. 6A along the section line D-D shown in FIG. 6B.

FIG. 6D schematically shows a cross-section through the section shown in FIG. 6A along the section line E-E shown in FIG. 6B.

### DETAILED DESCRIPTION

Here and below, features that recur in different figures are denoted in each case by the same or similar reference signs.

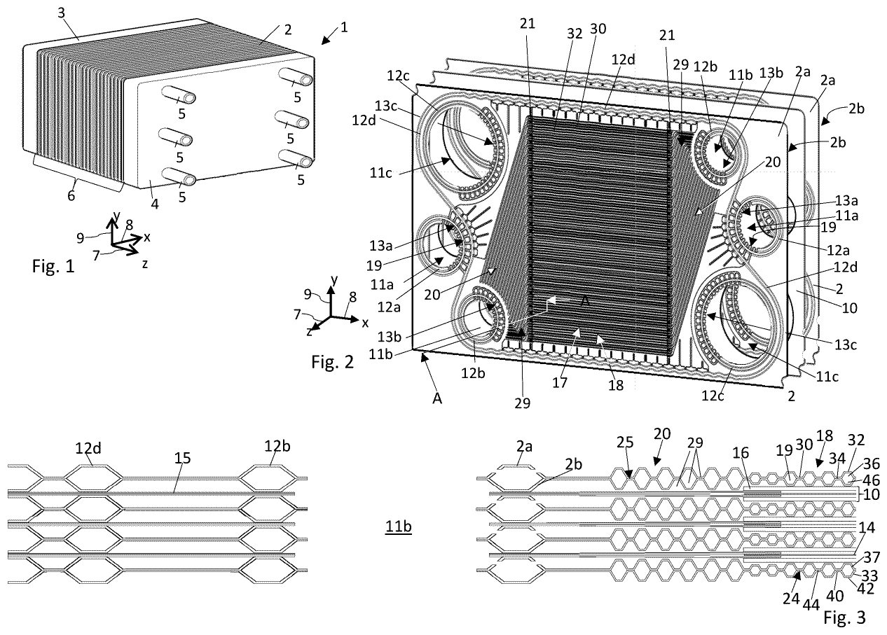

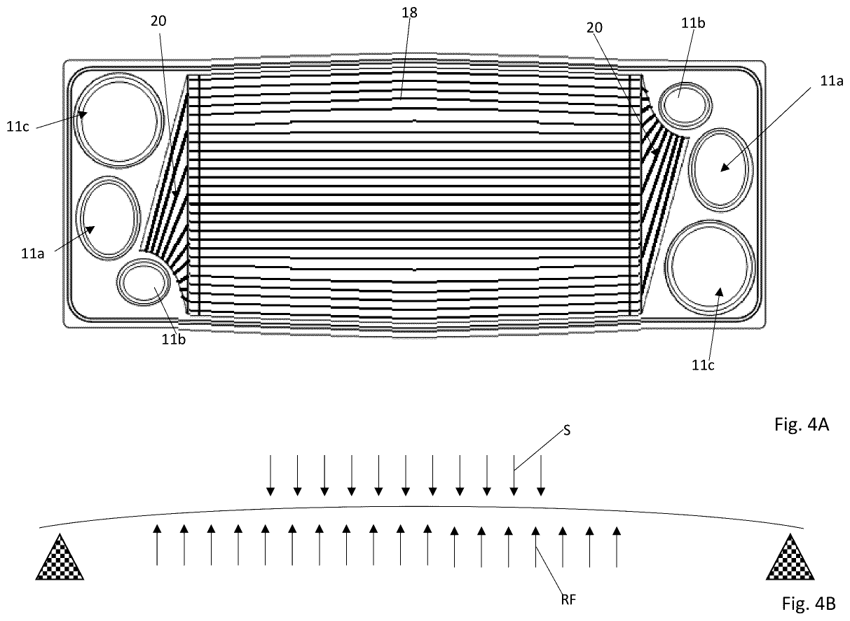

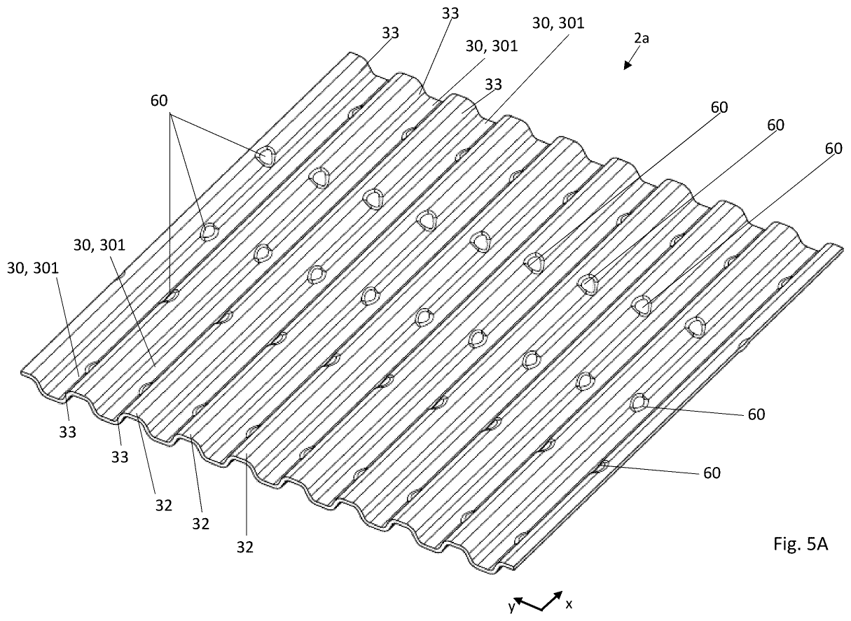

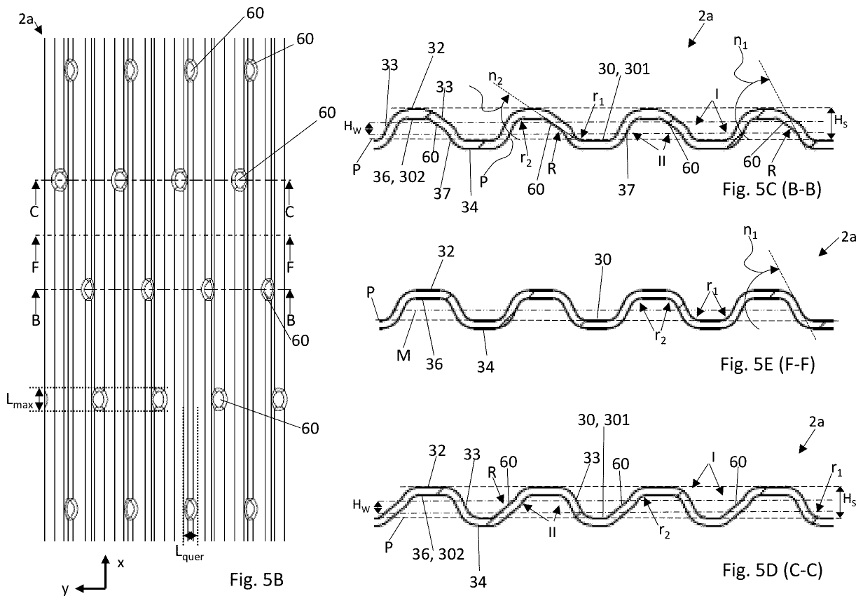

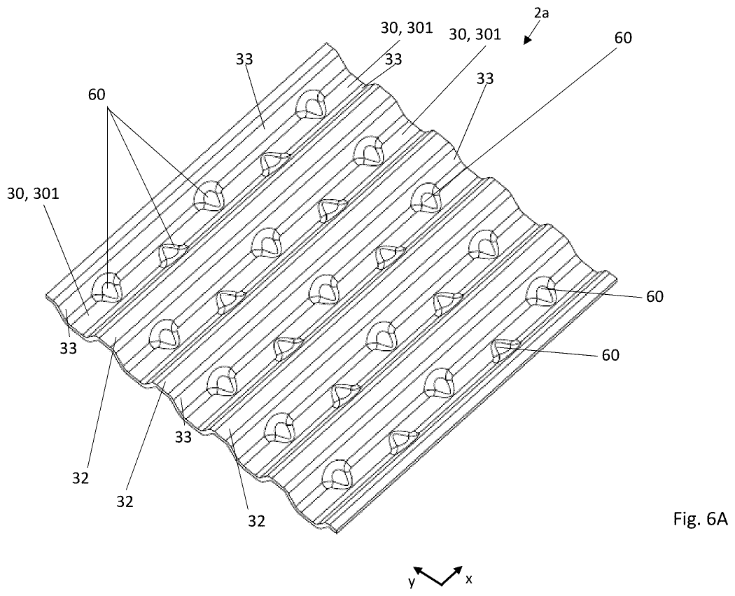

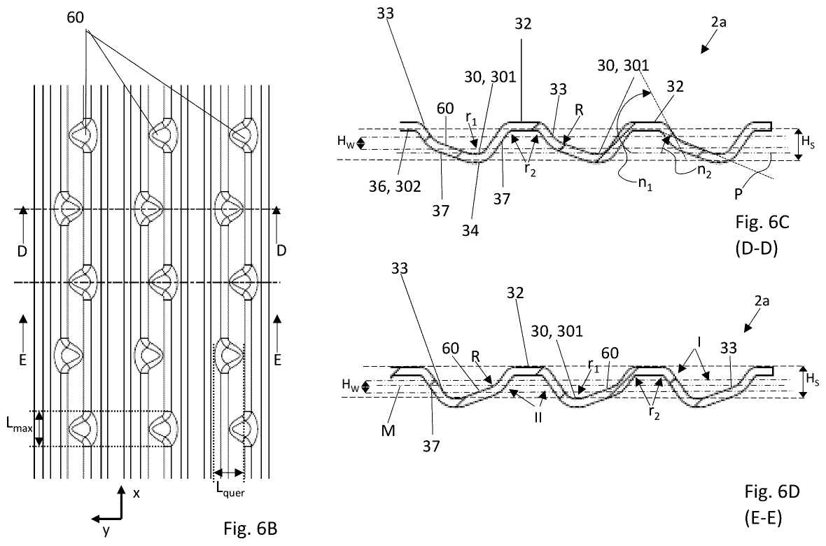

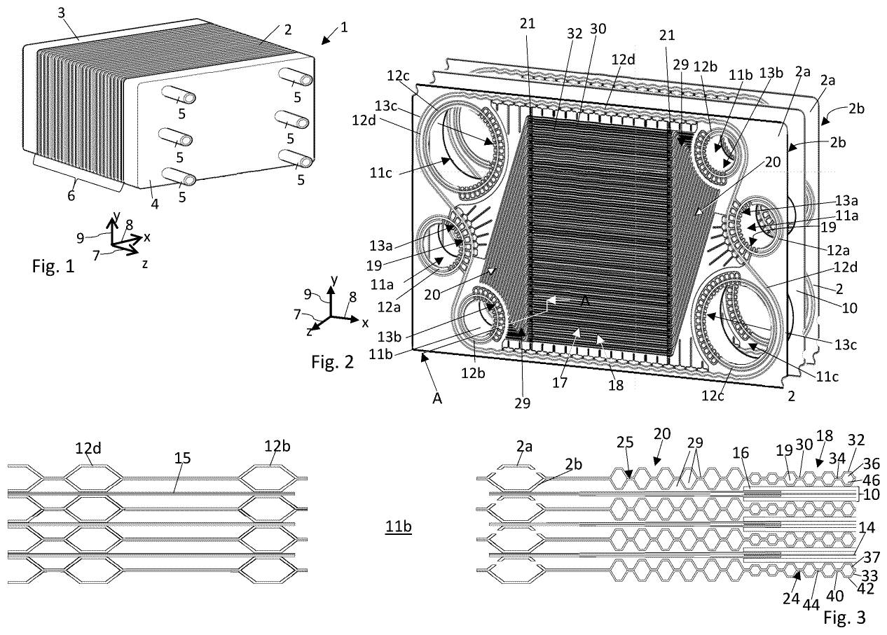

FIG. 1 shows an electrochemical system 1 comprising a plurality of structurally identical metal separator plates 2, which are arranged in a stack 6 and are stacked along a z-direction 7. The separator plates 2 of the stack 6 are clamped between two end plates 3, 4. The z-direction 7 is also referred to as the stacking direction. In the present example, the system 1 is a fuel cell stack. Two adjacent separator plates 2 of the stack enclose an electrochemical cell between them, which is used, for example, to convert chemical energy into electrical energy. For formation of the electrochemical cells of the system 1, a membrane electrode assembly (MEA) 10 is disposed in each case between adjacent separator plates 2 of the stack (see, for example, FIG. 2). Each MEA 10 typically contains at least one membrane, for example an electrolyte membrane. Furthermore, a gas diffusion layer (GDL) can be arranged on one or both surfaces of the MEA. This is not shown in FIGS. 1 and 2 but can be seen in FIG. 3, for example.

In alternative embodiments, the system 1 may equally be in the form of an electrolyzer, an electrochemical compressor or a redox flow battery. In these electrochemical systems, use may likewise be made of separator plates. The structure of these separator plates can then correspond to the structure of the separator plates 2 described in more detail here, even if the media fed onto or through the separator plate in an electrolyzer, in an electrochemical compressor or in a redox flow battery may differ in each case from the media used for a fuel cell system. Optionally, the separator plates can each comprise exactly one individual plate.

The z-axis 7 together with an x-axis 8 and a y-axis 9 defines a right-handed Cartesian coordinate system. The separator plates 2 each define a plate plane, whereby the plate planes of the individual plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media, which can be fed to the system 1 and which can be discharged from the system 1, may comprise, for example, fuels such as molecular hydrogen or methanol, reaction gases such as air or oxygen, reaction products such as water vapor, or depleted fuels or coolants such as water and/or glycol.

FIG. 2 shows, in perspective form, two adjacent separator plates 2 of an electrochemical system of the type of the system 1 of FIG. 1 and a membrane electrode assembly (MEA) 10 known from the prior art, which is arranged between these adjacent separator plates 2, the MEA 10 being largely concealed in FIG. 2 by the separator plate 2 that faces the observer. The separator plate 2 is formed from two individual plates 2a, 2b that are joined together in a materially bonded manner (see for example FIG. 3), of which only the first individual plate 2a that faces the observer and that conceals the second individual plate 2b is visible in FIG. 2. The individual plates 2a, 2b may each be manufactured from a metal sheet, e.g. from a stainless-steel sheet. The individual plates 2a, 2b may, for example, be welded to one another, e.g. by laser welded joints. On the one hand, the individual plates 2a, 2b can be tightly welded along and at a distance from their outer edges or at least along the inner edge of a part of the through-openings along sealing seams, in particular outside and/or inside the perimeter bead 12d. Further weld seams are possible, for example in the region between the channels 30, which will be explained later.

The individual plates 2a, 2b comprise through-openings, which are aligned with one another and which form through-openings 11a-c in the separator plate 2. When a plurality of separator plates of the type of the separator plate 2 are stacked, the through-openings 11a-c form ducts that extend in the stacking direction 7 through the stack 6 (see FIG. 1). Typically, each of the ducts formed by the through-openings 11a-c is fluidically connected to one of the ports or media connections 5 in the end plate 4 of the system 1. By way of the ducts formed by the through-openings 11a, it is possible for e.g. coolant to be introduced into the stack or discharged from the stack. By contrast, the ducts formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are formed substantially parallel to the plate plane.

In order to seal the through-openings 11a-c from the interior of the stack 6 and from to the environment, the first individual plates 2a each comprise sealing arrangements in the form of sealing beads 12a-c, which are each arranged around the through-openings 11a-c and which each completely enclose the through-openings 11a-c. The second individual plates 2b have corresponding sealing beads for sealing the through-openings 11a-c on the rear side of the individual plates 2 that face away from the viewer of FIG. 2 (not shown). Alternatively, elastomer seals can also be used.

In an electrochemically active region 18, the first individual plates 2a each have, on their side that faces the viewer of FIG. 2, a flow field 17 with structures for guiding a reaction medium along the outer side of the individual plate 2a. These structures are shown in FIG. 2 by a plurality of webs 32 and channels 30 that extend between the webs 32 and are delimited by the webs 32. On the outer side of each of the separator plates 2, that faces the viewer in FIG. 2, the first individual plates 2a also each have a distribution and collection region 20. Distribution or collection regions 20 each comprise structures that are set up to distribute a medium introduced into the distribution region 20 from a first of the two through-openings 11b among the channels of the active region 18 or to collect or bundle a medium flowing from the active region 18 towards the second of the through-openings 11b. The fluid-guiding structures 29 of both distribution or collection regions 20 are likewise provided in FIG. 2 by webs and channels that run between the webs and that are delimited by the webs. In the following text, among distribution and collection region, only the distribution region 20 will be discussed for the sake of simplicity; the corresponding statements can equally apply to a collection region 20.

The sealing beads 12a-12c have passages 13a-13c, which allow passage of medium between the associated through-openings 12a-12c and the respective distribution region 20 on one gas side or in the interior of the separator plate 2.

The first individual plates 2a also each comprise a further sealing arrangement in the form of a perimeter bead 12d that runs around the flow field 17 of the active region 18, the distribution and collection regions 20 and the through-openings 11b, 11c and seals them off from the through-opening 11a, i.e. from the coolant circuit, and from the environment of the system 1. The second individual plates 2b each comprise corresponding perimeter beads. The structures of the active region 18, the distribution structures of the distribution and collection region 20 and the sealing beads 12a-d are each formed integrally with the individual plates 2a and molded into the individual plates 2a or 2b, e.g. in an embossing or deep-drawing process or by means of hydroforming.

The separator plate 2 is formed from two individual plates, namely individual plates 2a, 2b, which are joined together with a material bond (see e.g. FIG. 3), of which only the first individual plate 2a facing the viewer is visible in FIG. 2, which conceals the second individual plate. The individual plates may each be formed of a shaped metal sheet, for example a stamped or deep-drawn stainless-steel sheet. This metal sheet may have, for example, a thickness of at most 150 μm, optionally at most 100 μm, optionally at most 70 μm, optionally at most 50 μm. The individual plates may be welded to one another, for example by laser-welded joints.

FIG. 3 schematically shows a cross-section through a portion of the plate stack 6 of the system 1 from FIG. 1, the cross-section plane being oriented in the z-direction and thus perpendicular to the plate planes of the separator plates 2. In FIG. 3, the cross-section plane runs along an offset section, along the sectional line A-A in FIG. 2. It should be noted that the separator plates in FIG. 3 are schematic and exemplary and serve to illustrate the structure of the electrochemical system, in particular the different layers and regions. On its side that faces away from the second individual plate 2b, the first individual plate 2a has integral, adjacent first channels 30 for guiding the media, which are separated from one another by first webs 32 formed between the first channels 30. On a side of the first individual plate 2a that faces the second individual plate 2b, the first channels 30 form first protrusions 34 and the first webs 32 form first grooves 36. On its side that faces away from the first individual plate 2a, the second individual plate 2b has integral second channels 40 running next to one another for guiding the media, which are separated from one another by second webs 42 formed between the second channels 40. Here, on a side of the second individual plate 2b that faces the first individual plate 2a, the second channels 40 form second protrusions 44 and the second webs 42 form second grooves 46.

Cooling channels are arranged in the cavity 19 between adjacent individual plates 2a, 2b. In the active region 18, the two individual plates 2a, 2b rest on each other in a contact region 24. The individual plates 2a and 2b can be joined to each other there. Optionally, the cooling channels as well as the first channels 30 and the second channels 32 extend parallel to each other in the active region 18.

A membrane electrode assembly (MEA) 10 known from the prior art, for example, is arranged between adjacent individual plates 2 of the stack. The MEA 10 typically comprises a membrane 14, e.g. an electrolyte membrane, and an edge portion 15 connected to the membrane 14. For example, the edge portion 15 can be bonded to the membrane 14, e.g. by an adhesive connection or by lamination.

In the present case, the term “electrochemically active region” is used to designate the region of the individual plates 2a, 2b that is opposite an electrochemically active region of the MEA 10 when the individual plate 2a, 2b is arranged in an electrochemical system. The membrane of the MEA 10 extends in each case at least over the active region 18 of the adjacent separator plates 2 and enables a proton transfer there via or through the membrane 14. The actual active region 18 is limited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining separator plates 2. The edge portion 15 can also extend outwards beyond the perimeter bead 12d and adjoin or protrude beyond the outer edge region of the individual plates 2a, 2b (see FIG. 2).

Furthermore, gas diffusion layers 16 may additionally be arranged in the active region 18. The gas diffusion layers 16 enable flow of gas to the membrane 14 over the largest possible region of the membrane surface and can thus improve the proton transfer across the membrane. The gas diffusion layers 16 can, for example, be arranged on both sides of the membrane 14 at least in the active region 18 between the adjacent separator plates 2. The gas diffusion layers 16 may be, for example, formed from a fiber felt or comprise a fiber felt.

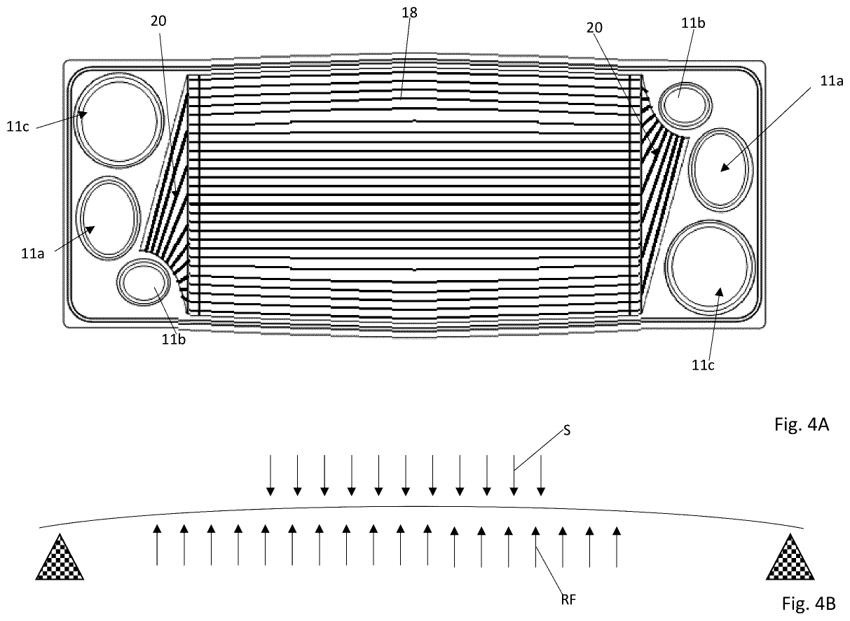

FIG. 4A shows a schematic top view of an exemplary individual plate of the prior art for a separator plate of an electrochemical system. FIG. 4B shows the individual plate of FIG. 4A schematically as a bending beam. In FIG. 4B, the springback RF, thus the relaxation of material after releasing it from the shaping tool, of the active region on the one hand and the stiffness S of the bending beam on the other hand are visualized by arrows. In the active region, compressive stresses that are present in the separator plate or that result from the manufacturing process lead to bulging effects that cause problems when the separator plates are used in an electrochemical system of the type shown in FIG. 1. These bulging effects can, for example, result in elements of the separator plate no longer fitting together with the elements of the MEA that interact with them or, in the case of two-layer separator plates, the elements of the individual plates are geometrically displaced relative to each other. Furthermore, the tools required for the subsequent processing steps may no longer fit. Difficulties can also arise during stacking. If this is only counteracted by stiffening the edge regions of the separator plates, this usually results in undesirable creases, so that this is not an effective countermeasure. The present disclosure has the task of counteracting these bulging effects.

Figure groups 5 and 6 each show only a first individual plate 2a. A second individual plate 2b could be designed without stiffening elements, or optionally also designed with stiffening elements. Two individual plates 2a, 2b may be present in a separator plate, in which at least some of the stiffening structures 60 of the first individual plate 2a overlap the stiffening structures 60 of the second individual plate 2b in an orthogonal projection onto the second individual plate 2b and/or are arranged offset with respect thereto. For example, the individual plates 2a, 2b can be mirror-symmetrical to one another in their active region 18.

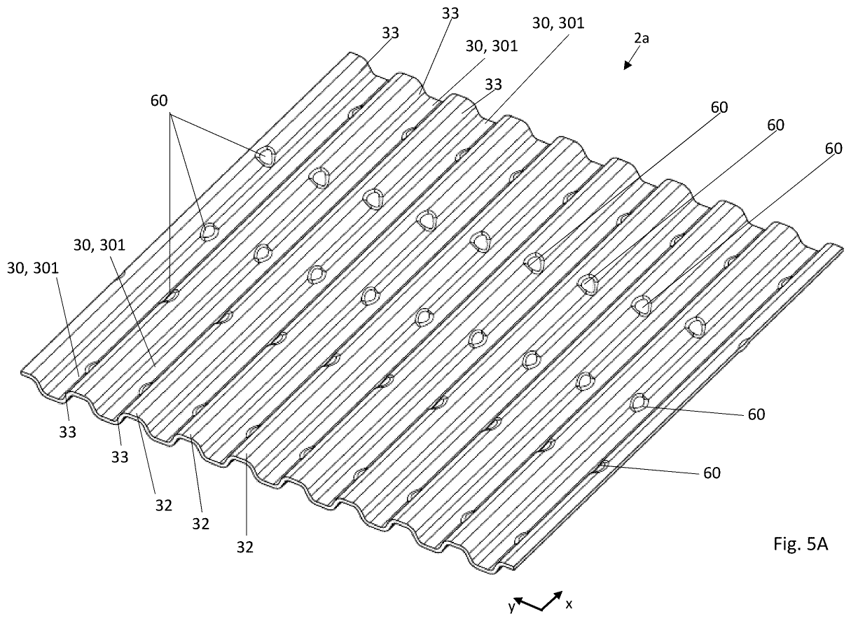

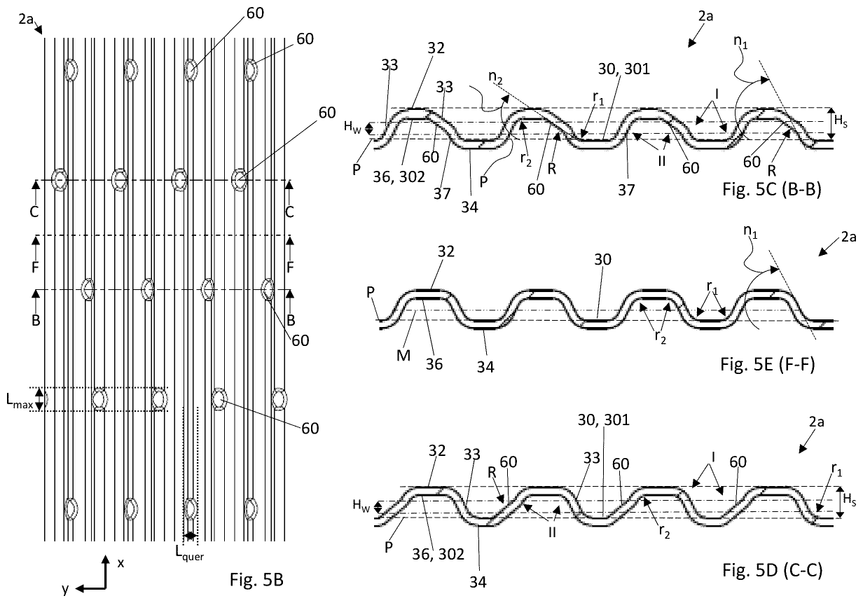

FIG. 5A shows a section of the active region 18 of an individual plate 2a of a separator plate 2 of a system of the type shown in FIG. 1.

The first individual plate 2a has webs 32 embossed on a first side. The webs have web flanks 33. The web flanks 33 laterally delimit channels 30 for guiding a first fluid. The channels are also delimited by channel bases 301.

Optionally, the stiffening structures 60 are only arranged in the active region 18 of the separator plate 2, while no stiffening structures are arranged in the distribution or collection region 20.

For the sake of clarity, only some of the webs 32, web flanks 33, channels 30, channel bases 301 or other elements are provided with the respective reference symbols in this figure, the previous and the following figures.

In FIG. 5A, the stiffening structures 60 are designed in such a way that the web height H_{S} does not change over the course of a web in the x-direction, but remains constant both in the region of the stiffening structures 60 and in the intermediate regions between the stiffening structures 60 closest to one another. The same applies to the channel depths.

FIG. 5B shows a top view of the section in FIG. 5A. FIG. 5B shows sections B-B and C-C, which are visualized in the following FIGS. 5C and 5D. The section B-B (FIG. 5C) and the section C-C (FIG. 5D) are each orthogonal to the longitudinal direction of extension of the webs 32.

The first individual plate 2a has, between channel bases 301 and the adjacent web flanks 33, first transition regions I with a first embossing radius r₁. On a second side of the individual plate 2a, the channels 30 form protrusions 34 and the webs 32 form grooves 36 for guiding a second fluid. Between groove bottoms 302 and adjacent protrusion flanks 37 forming the grooves, the individual plate 2a has second transition regions II with a second embossing radius r₂. The web flanks 33 of the first side of the individual plate 2a are opposite the protrusion flanks 37 of the second side of the individual plate 2a.

The individual plate 2a forms a plurality of stiffening structures 60, which are arranged in the first I and second II transition regions. The stiffening structures 60 are designed as local bulges. The bulges have a radius R that is larger than the respective embossing radius r₁, r₂. The bulges extend over a height H_{w} that is smaller than a web height H_{S}. The web height H_{S} can be measured along a direction orthogonal to the plate plane between the underside of the web or groove base 302 and the channel base 301. In cross-section B-B (FIG. 5C), the stiffening structures 60 are each formed on one side of one of the two protrusion flanks 37 that delimit the grooves. In cross-section C-C (FIG. 5D), the stiffening structures 60 are each formed on one side of one of the two web flanks 33 that delimit the channels. The protrusion flanks 37 forming the stiffening structures 60 in section B-B correspond to the web flanks 33 in section C-C, which do not form any stiffening structures 60, while the web flanks 33 with stiffening structures 60 in cross-section C-C correspond to the protrusion flanks 37, which do not form any stiffening structures 60 in section B-B. The stiffening structures 60 are therefore arranged offset along the longitudinal extension of the channels or webs 32.

The web flanks 33 may also have a first inclination n₁ relative to a plate plane P outside the stiffening structure 60 (in relation to the direction in which the channels extend). In the stiffening structure 60, the web flanks 33 have a second inclination n₂ relative to the plate plane P. The second inclination n₂ is less than the first inclination n₁. The plate plane P extends parallel to the x-y plane, in particular through the channel bases.

The stiffening structures 60 in the web flanks 33 and in the protrusion flanks 37 have the same dimensions in the present case, but may be configured differently in other embodiments.

The stiffening structures 60, shown in FIG. 5D, are bulged and protrude into the channel 30. The stiffening structures 60, which are shown in FIG. 5C and are formed in the second transition region II, are bulged and project into the groove 36.

The stiffening structures 60 have a maximum longitudinal extension Lₘₐₓ along the longitudinal channel extension or groove extension, which is greater than 0.1 times the web height H_{S} but less than 2.5 times the web height H_{S}. The stiffening structures, which are formed in a web flank, have a maximum lateral extension L_{quer} to the longitudinal channel extension or groove extension, which is greater than 0.2 times the channel width measured at half height in channel sections without local bulges and less than 0.9 times the channel width measured at half height in channel sections without local bulges. The stiffening structures, which are formed in a protrusion flank, have a maximum lateral extension transverse to the longitudinal channel extension or groove extension, which is greater than 0.2 times the groove width measured at half height in groove sections without local bulges and less than 0.9 times the groove width measured at half height in groove sections without local bulges. The web flank comprising the stiffening structure 60 is inclined by a maximum of 55° to the plate plane in the region of a maximum curvature of the stiffening structure 60. Line M represents the half-height line and is shown in FIG. 5E only for reasons of clarity for figure group 5.

As can be seen in FIGS. 5A to 5D, the stiffening structures 60 are arranged in a plurality of channels 30 and in a plurality of grooves 36. In this case, the stiffening structures 60 arise, in other words originate, alternately from a first and a second web flank 33 that delimit the respective channel in the longitudinal channel course. The stiffening structures originate alternately from a first and a second protrusion flank 37 in the longitudinal groove course. The stiffening structures 60 of a channel 30 are offset in the direction in which the channel extends relative to the stiffening structures 60 of an adjacent groove 36. In total, this results in a sequence of four different stiffening structures. The stiffening structures 60 have constant distances from one another in the longitudinal direction (x-direction) and in the transverse direction (y-direction).

Optionally, the webs 32 and channels 30 in an intermediate region between two closest stiffening structures 60 formed in the same webs 32 and/or channels 30 are shaped such that they have the same structure over the entire length of such an intermediate region. This means that the embossing radii r₁, r₂ and flank angles remain constant in the intermediate region. Optionally, an intermediate region extends over a length that is at least 1.5 times, optionally at least twice, optionally at least three times the length of a stiffening structure 60 in the x-direction.

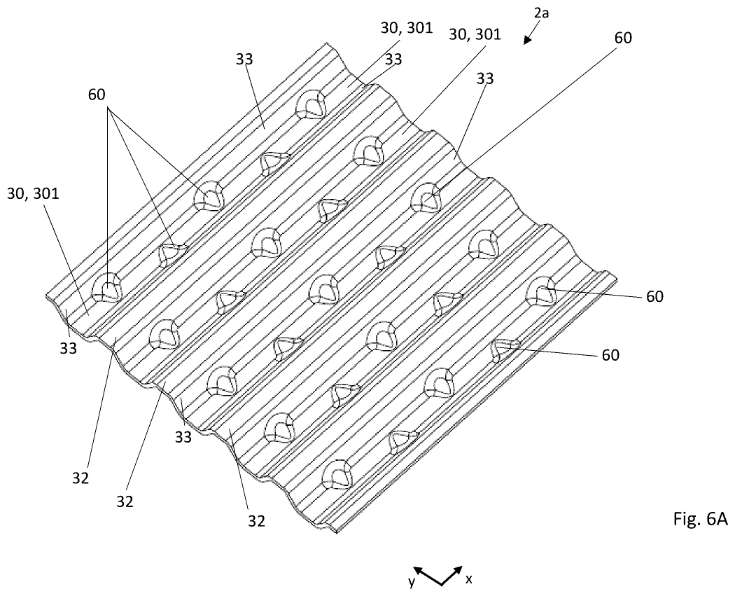

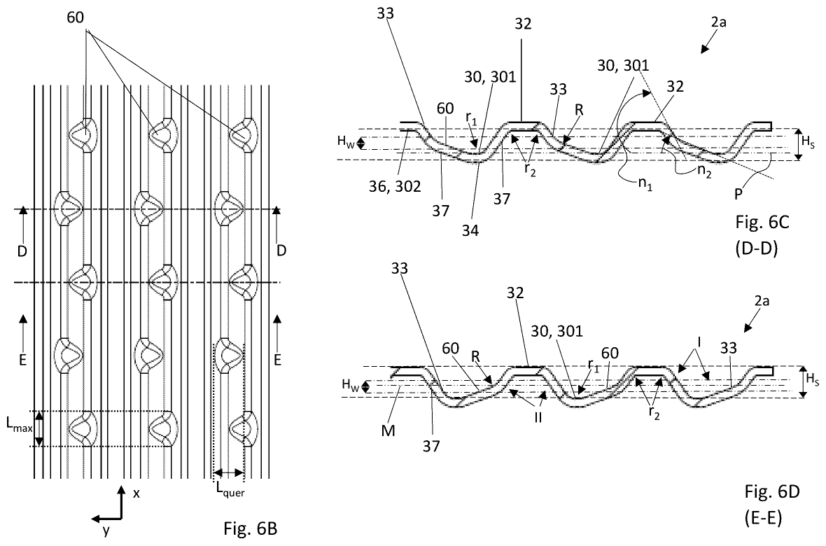

FIG. 6A shows a section of an individual plate 2a of a separator plate 2 of a system of the type shown in FIG. 1. The first individual plate 2a has webs 32 embossed on a first side. The webs 32 have web flanks 33. The web flanks 33 laterally delimit channels 30 for guiding a first fluid. The channels are also delimited by channel bases 301.

FIG. 6B shows a top view of the section in FIG. 6A. FIG. 6B shows cross-sections D-D and E-E, which are visualized in the following FIGS. 6C and 6D. The cross-section D-D (FIG. 6C) and the cross-section E-E (FIG. 6D) each run orthogonally to the longitudinal direction of extension of the webs 32. A cross-section between cross-sections D-D and E-E, i.e. a cross-section through an intermediate region between transverse stiffening regions, has not been shown here as it corresponds to cross-section F-F shown in FIG. 5E, particularly with regard to symmetries.

The first individual plate 2a has, between channel bases 301 and the adjacent web flanks 33, first transition regions I with a first embossing radius r₁. On a second side of the individual plate 2a, the channels 30 form protrusions 34 and the webs 32 form grooves 36 for guiding a second fluid. Between groove bottoms 302 and adjacent protrusion flanks 37 that delimit the grooves 36, the individual plate 2a has second transition regions II with a second embossing radius r₂. The web flanks 33 of the first side of the individual plate 2a are opposite the protrusion flanks 37 of the second side of the individual plate 2a.

The individual plate 2a forms a plurality of stiffening structures 60, which are arranged in the first transition regions I. The stiffening structures 60 are configured as local bulges. The bulges have a radius R that is larger than the respective embossing radius r₁, r₂. The bulges extend over a height H_{w} that is smaller than a web height H_{S}. The web height H_{S} can be measured along a direction orthogonal to the plate plane between the underside of the web or groove base 302 and the channel base 301. In cross-section D-D (FIG. 6C), the stiffening structures 60 are each formed on one side of one of the two web flanks 33 that delimit the channels 30. In cross-section E-E (FIG. 6D), the stiffening structures 60 are formed on the other side of each of the two web flanks 33 that delimit the channels 30.

As can be seen in FIGS. 6A to 6D, the stiffening structures 60 are arranged in a plurality of channels. In this case, the stiffening structures 60 originate alternately from a first and a second web flank 33 that delimit the respective channel 30 in the longitudinal course of the channel.

The stiffening structures 60 have constant distances from one another in the longitudinal direction (x-direction) and in the transverse direction (y-direction).

The web flanks 33 have a first inclination n₁ relative to a plate plane P. In the stiffening structure 60, the web flanks 33 have a second inclination n₂ relative to the plate plane P. The second inclination n₂ is less than the first inclination n₁. The plate plane P extends parallel to the x-y plane, in particular through the channel bases.

The stiffening structures 60 in the web flanks 33 have the same dimensions in the present case, but may be configured differently in other embodiments.

The stiffening structures 60, shown in FIGS. 6C and 6D, are bulged and each protrude into a channel 30.

The stiffening structures 60 have a maximum longitudinal extension Lₘₐₓ along the longitudinal channel extension or groove extension which is greater than 0.1 times the web height H_{S} but less than 2.5 times the web height H_{S}. The stiffening structures, which are formed here in a web flank, have a maximum lateral extension L_{quer} to the longitudinal channel extension or groove extension, which is greater than 0.2 times the channel width measured at half height in channel sections without local bulges and less than 0.9 times the channel width measured at half height in channel sections without local bulges. In FIG. 6, the web flank comprising the stiffening structure 60 is inclined by a maximum of 45° to the plate plane P in the region of a maximum curvature of the stiffening structure 60. Again, half the height is represented by a line M, here in FIG. 6D.

1. A separator plate for an electrochemical system, comprising a first individual plate, wherein the first individual plate has, embossed on a first side, webs with web flanks that in sections delimit channels, wherein the channels are configured for guiding a first fluid, wherein the first individual plate has, between bases of the channels and the adjoining web flanks, first transition regions with a first embossing radius;
wherein, on a second side of the first individual plate, the channels form protrusions and the webs form grooves for guiding a second fluid, wherein the first individual plate has, between bases of the grooves and adjoining flanks of the protrusions that form the grooves, second transition regions with a second embossing radius;
wherein the first individual plate forms a plurality of stiffening structures that are arranged in the first transition regions and/or the second transition regions, wherein the stiffening structures form local bulges, wherein the bulges have a radius which is greater than the respective embossing radius and wherein the bulges extend over a height that is less than a web height.

2. The separator plate according to claim 1, wherein at least some of the stiffening structures in the first transition region are bulged and project into the channels and/or wherein at least some of the stiffening structures in the second transition region are bulged and project into the grooves.

3. The separator plate according to claim 1, wherein the stiffening structures have a maximum longitudinal extension along a longitudinal channel extension or groove extension which is greater than 0.1 times the web height,
and/or
wherein the stiffening structures have a maximum longitudinal extension along the longitudinal channel extension or groove extension that is smaller than 2.5 times the web height.

4. The separator plate according to claim 1, wherein the stiffening structures have a maximum longitudinal extension along a longitudinal channel extension or groove extension, which is greater than 120 μm,
and/or
wherein the stiffening structures have a maximum longitudinal extension along the longitudinal channel extension or groove extension which is less than 3 mm.

5. The separator plate according to claim 1, wherein the stiffening structures have a maximum lateral extension within the respective channel or within the respective groove, transversely to a longitudinal channel extension or groove extension, respectively, which is greater than 0.2 times the channel or groove width measured at half height in sections of the same channel or groove without local bulges,
and/or
wherein the stiffening structures in the channels have a maximum lateral extension transverse to the longitudinal channel extension or groove extension, which is smaller than the channel width measured at half height in channel sections without local bulges,
and/or
wherein the stiffening structures in the grooves have a maximum lateral extension transverse to the longitudinal channel extension or groove extension, which is smaller than the groove width measured at half height in groove sections without local bulges.

6. The separator plate according to claim 1, wherein the height of the stiffening structures is at most 95% of the web height.

7. The separator plate according to claim 1, wherein the web flanks comprising the stiffening structures are inclined by a maximum of 55° relative to a plate plane in a region of a maximum curvature of the stiffening structures.

8. The separator plate according to claim 1, wherein the stiffening structures are arranged in a plurality of the channels and/or a plurality of the grooves.

9. The separator plate according to claim 1, wherein the stiffening structures originate in a longitudinal channel course from a first and/or a second web flank that delimits the respective channel and/or alternately originate in a longitudinal groove course from a first and/or a second protrusion flank that delimits the respective groove.

10. The separator plate according to claim 1, wherein the stiffening structures are arranged only in the channels or only in the grooves.

11. The separator plate according to claim 1, wherein the stiffening structures of a channel are arranged offset in a channel extension direction relative to the stiffening structures of an adjacent groove.

12. The separator plate according to claim 1, wherein the separator plate has more stiffening structures in central regions of the separator plate than in edge regions of the separator plate.

13. The separator plate according to claim 1, wherein the stiffening structures are distributed over the separator plate and have at least regionally constant and/or at least regionally varying distances from one another.

14. The separator plate according to claim 1, wherein at least two of the stiffening structures have different geometries.

15. The separator plate according to claim 1, comprising a second individual plate connected to the first individual plate,
wherein the second individual plate has, embossed on a first side of the second individual plate, webs with web flanks that in sections delimit channels for guiding a third fluid, wherein the second individual plate has, between bases of the channels and the adjoining web flanks, third transition regions with a third embossing radius;
wherein, on a second side of the second individual plate, the channels form protrusions and the webs form grooves for guiding the second fluid, wherein the second individual plate has fourth transition regions with a fourth embossing radius between bases of the grooves and adjacent flanks of the protrusions that delimit the grooves at least in sections.

16. The separator plate according to claim 15, wherein the second individual plate forms a plurality of stiffening structures arranged in the third transition regions and/or the fourth transition regions, wherein the stiffening structures in the third transition regions are locally bulged into the channels and in the fourth transition regions are locally bulged into the grooves, wherein the bulges have a radius which is larger than the respective embossing radius and the bulges are smaller than a web height of the second individual plate.

17. The separator plate according to claim 16, wherein the stiffening structures of the first individual plate differ, at least in some of their properties, from the stiffening structures of the second individual plate.

18. The separator plate according to claim 15, wherein at least some of the stiffening structures of the first individual plate in an orthogonal projection onto the second individual plate overlap and/or are offset from the stiffening structures of the second individual plate.

19. An electrochemical system comprising a plurality of separator plates according to claim 1.
